(19) United States
(12) Patent Application Publication
(10) Pub. No.: US 2019/0315421 A1
(43) Pub. Date: Oct. 17, 2019

(54) PIVOTING BICYCLE SEAT

(71) Applicant: Salvatore Deiana, Vancouver (CA)

(72) Inventor: Salvatore Deiana, Vancouver (CA)

(21) Appl. No.: 16/304,639

(22) PCT Filed: Jun. 2, 2017
(86) PCT No.: PCT/CA2017/050675

§ 371 Date: Nov. 26, 2018

(30) Foreign Application Priority Data
Jun. 14, 2016 (US) 15181967

(51) Int. Cl. B62J 1/04; B62J 1/00; B62J 1/08

(52) U.S. Cl. CPC B62J 1/04; B62J 1/007; B62J 1/08; B62J 1/002

(57) ABSTRACT

A bicycle seat assembly (10) for reducing frictional and pressure discomfort to the buttocks and urogenital region of a cyclist. The seat assembly provides a horizontal pivot assembly (20) for rotation of a bicycle seat (12) about a longitudinal axis of a bicycle to accommodate the movement of the cyclist's legs and hips while pedaling, and a bracket assembly (32) connecting the horizontal pivot assembly to a post (34). The bicycle seat assembly may also provide a vertical pivot assembly (40) operatively coupled between the seat and the horizontal pivot assembly for rotation of the seat about a vertical axis to provide additional relief of frictional and pressure discomfort.

### CROSS-REFERENCE TO RELATED APPLICATIONS

This application is a national phase application of a PCT International Application Ser. No. PCT/CA2017/050675 filed on Jun. 6, 2017, that claims the benefit of co-pending U.S. Non-Provisional application Ser. No. 15/181,967 filed on Jun. 14, 2016, which is hereby expressly incorporated by reference in its entirety for all purposes.

### BACKGROUND OF THE INVENTION

The present invention relates to bicycles, and more particularly to bicycle seats. Bicycle riding on a conventional seat is a pain in the seat, causing urogenital friction. This reality has discouraged many people from riding a bike.

Many contraptions for bicycle seats have been tried, yet none seem to offer a solution for relieving rider discomfort. The problem lies in the momentum that is lost when a cyclist tries to throw the weight of their upper body in order to contribute to the effort applied by the cyclist's leg against the pedal. The forces applied by the cyclist encounters resistance from the body's stationary midsection in not only noncooperating but also interrupts this momentum continuum intended to reach the limb in question.

As can be seen, there is a need for an improved bicycle seat that moves in synchrony with the upper and lower body as the rider pedals.

### SUMMARY OF THE INVENTION

In one aspect of the of the present invention, a bicycle seat assembly includes: a seat having an upper surface configured to support the buttocks of a cyclist; a horizontal pivot assembly operatively coupled to a bottom surface of the seat for rotation of the seat about a longitudinal centerline of the bicycle; a bracket assembly operatively connected between the horizontal pivot assembly and a post; wherein the post is adapted to connect the bicycle seat assembly to the bicycle. The horizontal pivot assembly may further include a pivot shaft attached at a fore and an aft end thereof to the bracket assembly; a distended portion extending from a bottom portion of the seat having a hole defined therein that extends along a longitudinal centerline of the distended portion; with the pivot shaft received through the hole. In some embodiments, the horizontal pivot assembly includes a bearing disposed to support the pivot shaft for rotational movement within the hole and the bearing may be a roller bearing. One or more stops may be configured to limit a left and a right rotation of the seat around the shaft. A biasing means may also be included to urge the seat to a neutral position.

In other aspects of the invention, the bicycle seat assembly may also be provided with a vertical pivot assembly that is operatively coupled between the seat and the horizontal pivot assembly for rotational movement of the seat about a vertical axis. The vertical pivot assembly may include a pivot pin extending from the bottom surface of the seat; and a pivot plate having an aperture adapted to receive the pivot pin. As with the longitudinal pivot assembly, the vertical pivot assembly may include a pivot stop extending from the bottom surface of the seat; and an arcuate slot formed in the pivot plate adapted to receive the pivot stop. In some embodiments, a seat retainer is coupled to the pivot stop to retain the seat on the pivot plate. The vertical pivot assembly may further include a pivot disk supported in the pivot plate via a bearing, wherein the aperture is defined in the pivot disk. A bias mechanism may be included to urge the seat in a neutral condition about the vertical axis.

### BRIEF DESCRIPTION OF THE DRAWINGS

FIG. 9 is a side elevation view of yet another embodiment of a bicycle seat assembly in accordance with the present invention.

FIG. 9B is a front sectional view of the bicycle seat assembly in accordance with the embodiment of FIG. 9.

FIG. 10 is cross-sectional view of a socket and ball assembly in accordance with the embodiment of FIG. 9.

FIG. 11 is a front perspective view of a collar in accordance with the embodiment of FIG. 9.

FIG. 11B is a side view of an assembly of a ball and a collar in accordance with the embodiment of FIG. 9, and

FIG. 12 is a side elevation view of an embodiment of a post and ball assembly in accordance the present disclosure.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a bicycle seat that provides for pivotal movement of a bicycle seat to accommodate for the smooth application of pedaling forces by a cyclist.

The seat can be made to move forward and back or side to side.

The present invention was made after a lifetime of observation of how cyclists shift their body as they pedal. Pedaling is about shifting the body side to side in a rolling fashion and the seat should likewise mimic this movement and eliminate the friction in the cyclist's groin and seat area.

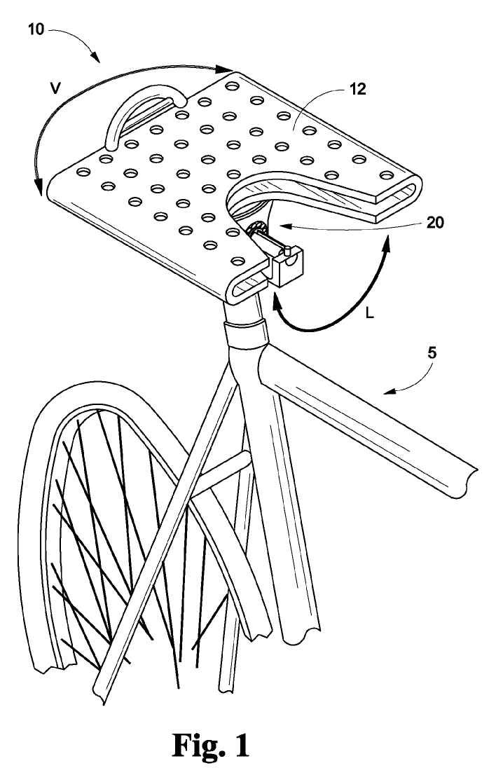

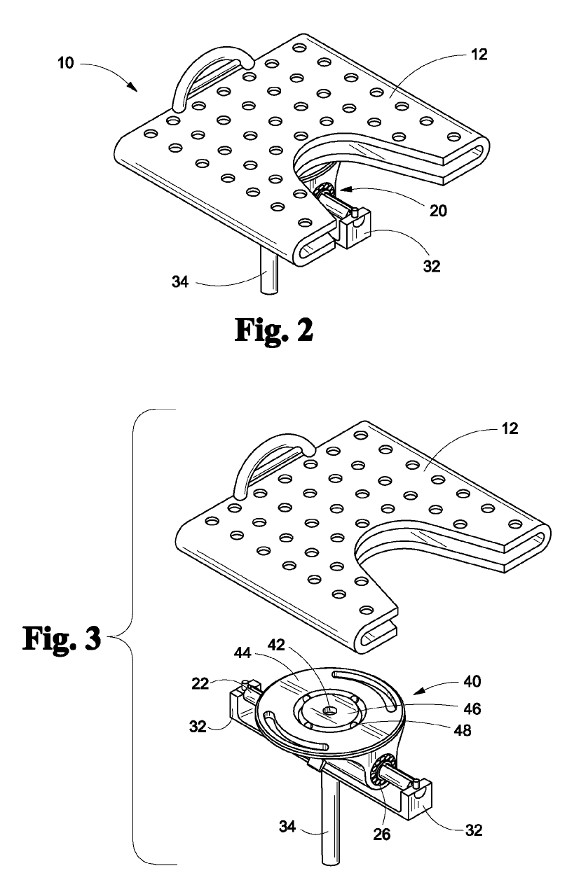

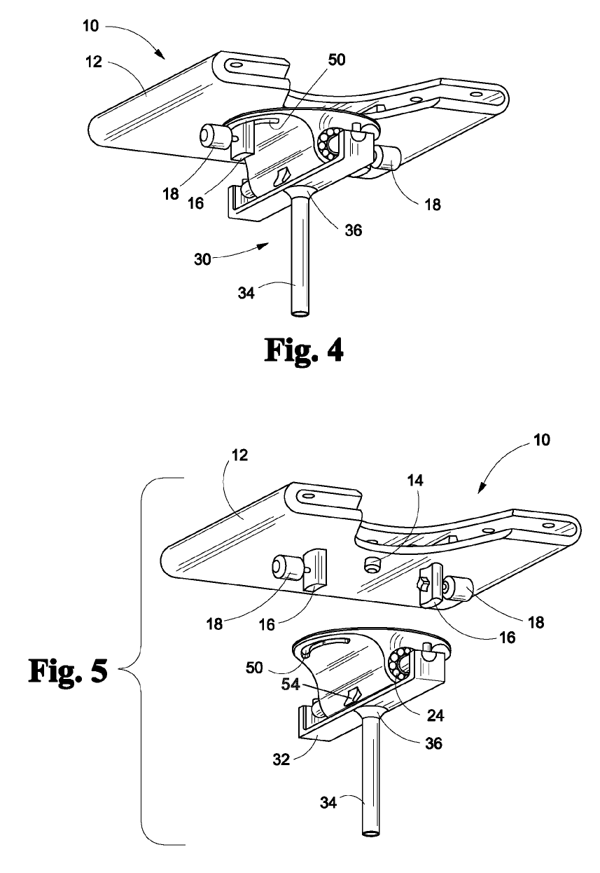

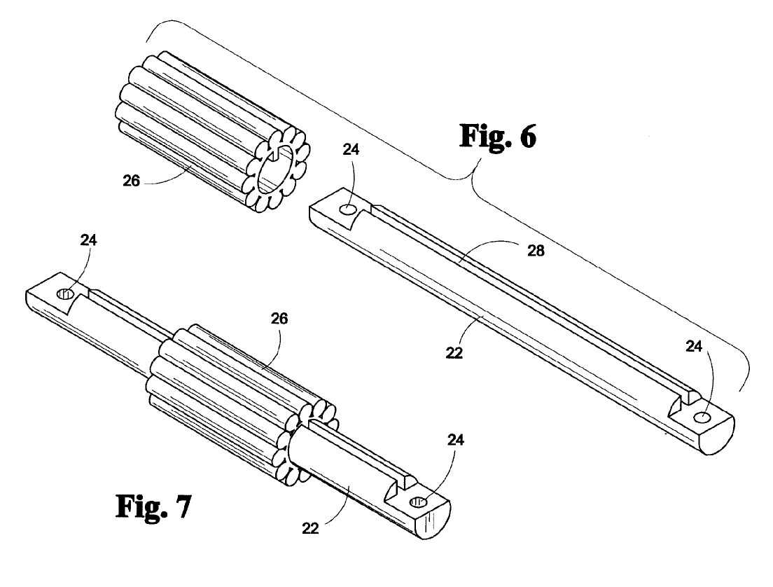

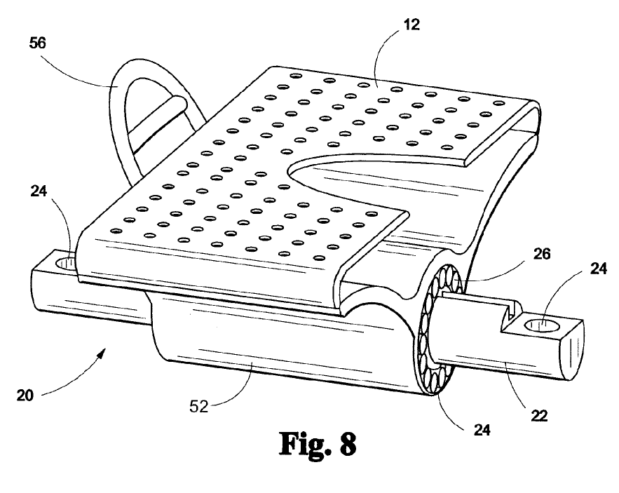

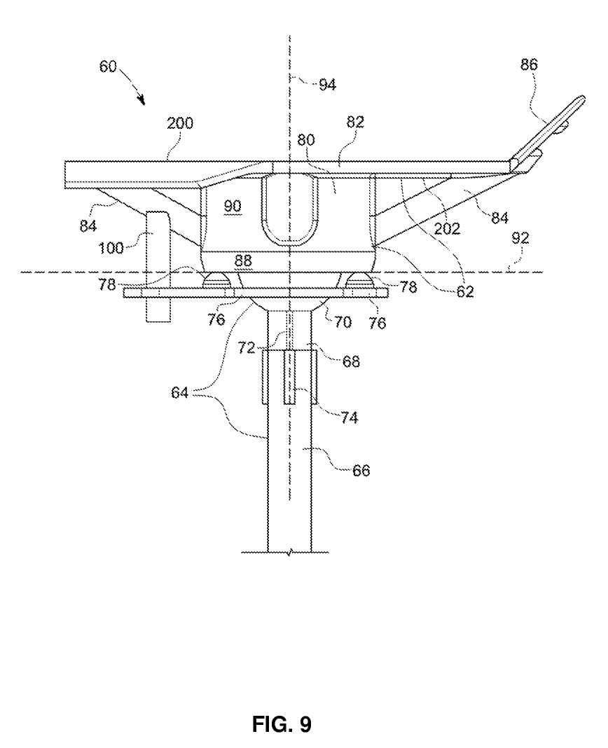

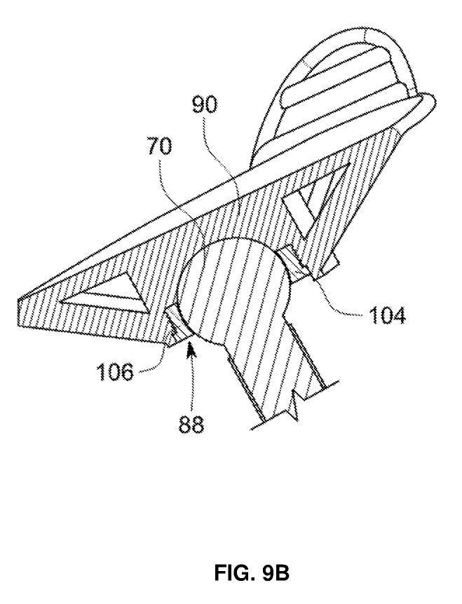

FIG. 9 shows another embodiment of a bicycle seat assembly 60 in accordance with the present invention. The bicycle seat assembly 60 includes a seat and socket portion 62 and a ball and post portion 64. The seat and socket portion 62 includes seat 82 that has an upper surface 200 configured to support the buttocks of a cyclist and also has a bottom surface 202. The seat 82 can also be referred to as a seat portion.

The ball and post portion 64 constitutes a bracket assembly and comprises a post 66, a neck 68, a bracket 76 and a ball 70, the ball 70, the neck 68 and the bracket 76 being distinct elements of the bracket assembly. In several alternate embodiments, the ball 70, the neck 68 and the bracket 76 can be made as a single cast steel element with equivalents of the ball 70 and the neck 68 being hollow to avoid excessive weight. The neck 68 includes a series ribs 72 to fit inside grooves defined by the post 66. That is, the post 66 is configured and sized to receive the neck 68. Further, the post 66 is configured to receive and hold the ribs 72 when the ribs 72 are aligned with the grooves 74 and the post 66 and neck 68 are pushed against each other.

The bracket 76 has a pair of bearings 78 to keep seat from tilting forward or back and to allow only sideway rolling and horizontal rotation. The seat and socket portion 62 has a socket assembly 80 that comprises a socket 90, a collar 88, a seat 82 and connecting members 84 that connect the seat 82 to the socket 90. The socket assembly 80 acts as a horizontal and vertical pivot assembly. The socket 90 can be secured to the seat 82 through any suitable means. In some embodiments, the socket 90, the seat 82 and the connecting members 84 can be manufactured as a single element. An aft stop rail 86 is secured to the seat 82 in order to support an aft aspect of the cyclist buttocks.

The socket assembly 80 comprises the collar 88 and the socket 90, which are configured to be secured to each other through any suitable means.

FIG. 9B is a front sectional view of the bicycle seat assembly 60 in accordance with the embodiment of FIG. 9. As an example, in the present embodiment, the collar 88 is a threaded collar and the socket 90 is a threaded socket. The threads on the threaded collar 88 are outer threads and the threads on the threaded socket 90 are inner threads. However, this need not be the case. That is, without departing from the scope of the invention, the threaded collar could have inner threads and the threaded socket could have outer threads.

The socket assembly 80 is rotationally coupled to the ball 70 and the seat and socket portion 62 can rotate about two axes, the first axis being axis 92 (horizontal axis or longitudinal axis or longitudinal centerline of the bicycle) and the second axis being axis 94. As such, the socket assembly 80 can be said to be part of a horizontal pivot assembly as well as a part of a vertical pivot assembly.

The bracket 76, the neck 68 and the ball 70 connect, to the post 66, the elements (e.g. the socket assembly 80) that are pivotally connected to the ball 70. The bracket 76, the neck 68 and the ball 70 can be referred to as a bracket assembly.

The bicycle seat assembly 60 can be configured to receive a locking mechanism to prevent any rotation until after the cyclist sits on the bicycle seat assembly and is ready to pedal. Such a locking mechanism can be in the form of a locking pin and a hole in the socket 90 and the ball 70. The locking pin is fitted the hole to lock the socket 90 to the ball 70. When the locking pin is removed, the bicycle seat assembly 10 is free to rotate.

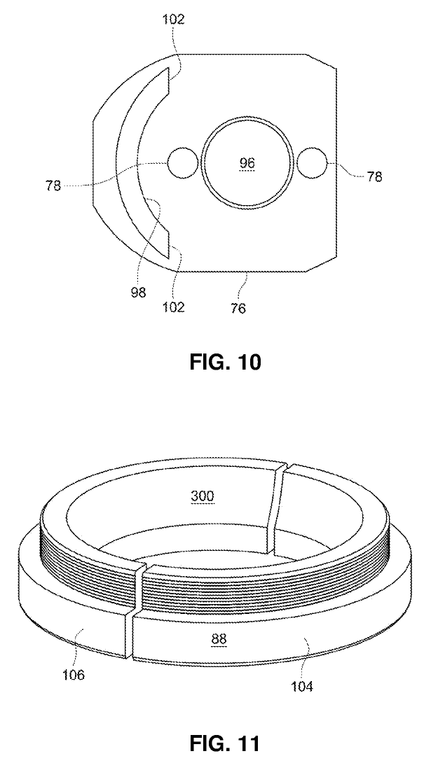

FIG. 10 shows a cross-sectional view of the bracket 76. The bearings 78 are shown, diametrically opposed across the (hollow) ball 70. The bracket 76 defines a slot 98. The seat and socket portion 62 comprises a post 100 (FIG. 9) secured thereto and extending downwardly. When the seat and socket portion 62 is secured to the ball 70, the post 100 fits through the slot 98. The slot 98 and post 100 prevent the seat and socket portion 62 from rotating about the axis 94 beyond an angular range defined by the slot edges 102. The post 100 can be secured to the rest of the seat and socket assembly 62 through any suitable means. For example, the post 100 can have threads formed thereon and the rest of the seat and socket assembly 62 can have a threaded aperture in which the post 100 can be screwed. Alternatively, as non-limiting examples, any suitable snap-fit mechanism or any type of key and lock retaining mechanism can be used.

The rotation of the seat and socket portion 62 about the axis 92 in one angular direction is limited by the seat and socket assembly 92 (the collar 88) coming in contact with (pushing against) the bracket 76. In the opposite angular direction, the rotation of the seat and socket portion 62 about the axis 92 is also limited by the socket assembly (the collar 88) coming in contact with the bracket 76.

The bracket assembly (the bracket 76, the neck 68 and the ball 70) connects the socket assembly 80 to the post 66. As the socket assembly is part of the aforementioned horizontal pivot assembly and of the vertical pivot assembly, it can be said that the bracket assembly connect the horizontal pivot assembly to the post.

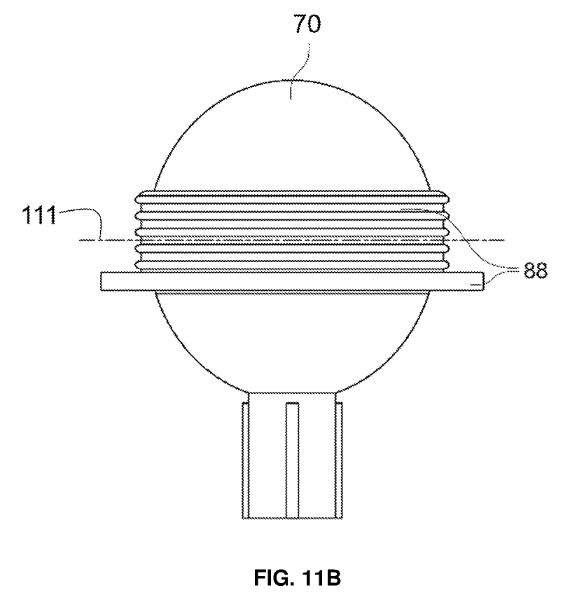

In the present embodiment, the collar 88 is a split collar having a first portion 104 and a second portion 106, as shown in FIG. 11. FIG. 11B is side view of an assembly of the ball 70 and the collar 88 in accordance with the embodiment of FIG. 9. To connect the seat and socket assembly 62 to the ball 70, one places the first portion 104 and the second portion 106 next to each other and below the equator 111 of the ball 70. Following this, the socket 90, without the post, 100 is lowered onto the ball 70 and the socket 90 is rotated with respect to the collar 88 in order to screw the socket 90 onto the collar 88. The post 100 can subsequently be installed.

The split collar can be manufactured by first making a threaded collar and then cutting it in the two portions 104 and 106. When cutting the collar 88 with a saw, the kerf of the saw will remove material between the portions 104 and 106. As such, abutting the portions 104 and 106 against each other will not result in a truly circular collar and is unlikely to allow proper fastening of the collar 88 to the socket 90. To remedy the situation, a gasket having a thickness equal to the kerf of the saw blade can be inserted at each junction of the portions 104 and 105.

As shown in FIG. 11, the collar 88 defines a portion 300 of a cupola. The inner surface of the socket 90 defines the remainder of the cupola, which is configured to rotate about the ball 70.

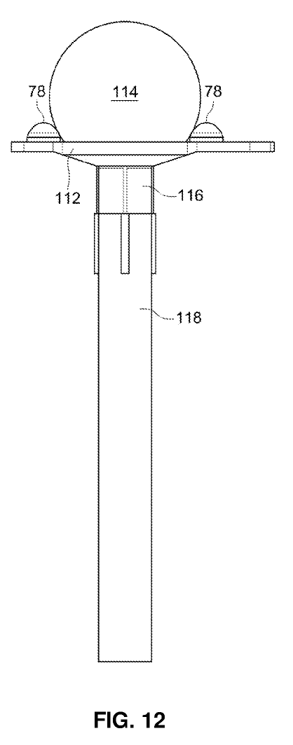

FIG. 12 shows a side view of another embodiment of a post and ball assembly 110. In this embodiment, a bracket 112, a ball 114 and a neck 116 are made as a single cast steel element and are secured to a post 118 by inserting the neck 116 into the post.

Alternatively, and as would be understood by a worker skilled in the art, the ball, neck and bracket can be manufactured separately and then assembled through any suitable process (e.g. welding).

It should be understood, of course, that the foregoing relates to exemplary embodiments of the invention and that modifications may be made without departing from the spirit and scope of the invention as set forth in the following claims.

1. A bicycle seat assembly, comprising:
a seat portion having an upper surface configured to support the buttocks of a cyclist;
a horizontal and vertical pivot assembly operatively coupled to a bottom surface of the seat portion for rotation of the seat portion about a longitudinal centerline and a vertical axis, of a bicycle;
a bracket assembly connecting the horizontal and vertical pivot assembly to a post;
wherein the post is adapted to connect the bicycle seat assembly to the bicycle.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. The bicycle seat assembly of claim 1, wherein:
the horizontal and vertical pivot assembly includes a socket assembly, the socket assembly including a socket towards the bottom surface of the seat and a collar secured with the socket;
the bracket assembly includes a ball and post portion including a ball, a neck and a bracket;
wherein the neck is adapted to be attached with the post of the bicycle;
wherein the collar is adapted to receive the ball in order to rotationally couple the horizontal and vertical pivot assembly with the bracket assembly.

15. The bicycle seat assembly of claim 14, wherein the neck includes a series of ribs to fit inside grooves defined by the post.

16. The bicycle seat assembly of claim 14, wherein the ball, the neck and the bracket are made up as a single element.

17. The bicycle seat assembly of claim 14, further comprising connecting members that connect the seat portion to the socket.

18. The bicycle seat assembly of claim 14, further comprising a locking mechanism including a locking pin adapted to be received into respective holes in the socket and the ball.

19. The bicycle seat assembly of claim 14, wherein the horizontal and vertical pivot assembly includes a post secured thereto and extending downwardly and the bracket defines a slot adapted to receive the post of the horizontal and vertical pivot assembly, in order to prevent the horizontal and vertical pivot assembly from rotating about the vertical axis, beyond an angular range defined by the slot.

20. The bicycle seat assembly of claim 14, wherein the collar is adapted to prevent the horizontal and vertical pivot assembly from rotating about a horizontal axis, beyond an angular range, by the collar coming in contact with the bracket.

21. The bicycle seat assembly of claim 14, wherein the collar is a split collar having a first portion and a second portion.

22. The bicycle seat assembly of claim 14, wherein the bracket includes a pair of bearings to restrain the seat from tilting towards or away from direction of motion of the bicycle.
